(19) United States
(12) Patent Application Publication
(10) Pub. No.: US 2026/0356346 A1
(43) Pub. Date: Nov. 12, 2026

(54) SYSTEMS AND METHODS FOR PERFORMING ENGINE-ASSISTED CHARGING FOR EXTENDED RANGE ELECTRIC VEHICLES

(71) Applicants: Hyundai Motor Company, Seoul (KR); Kia Corporation, Seoul (KR)

(72) Inventor: Joseph H. Parsons, Superior Township, MI (US)

(21) Appl. No.: 19/200,250

(22) Filed: May 6, 2025

(51) Int. Cl. B60W 20/13; B60L 50/62; B60L 53/62; B60L 53/63; B60W 10/06

(52) U.S. Cl. CPC B60W 20/13; B60L 50/62; B60L 53/62; B60L 53/63; B60W 10/06; B60L 2250/00; B60W 2510/244; B60W 2710/06

(57) ABSTRACT

Systems and methods for performing engine-assisted charging for an extended range electric vehicle (EREV) are provided. The method may comprise, using a computing device comprising a processor and a memory, determining whether a maximum output of a charging station, coupled to the EREV, is less than a power receiving capacity of the EREV, and, when the maximum output of a charging station is less than the power receiving capacity of the EREV, enabling engine-assisted charging. Enabling the engine-assisted charging may comprise determining an output needed from a generator of the EREV powered by an engine of the EREV, starting the engine, causing the generator to generate power and causing a battery of the EREV to be charged using the charging station and the generator, and coordinating, using a battery management system, a charging process from both the charging station and the generator,

### BACKGROUND

### Technical Field

Embodiments of the present disclosure relate to systems and methods for performing engine-assisted charging for extended range electric vehicles (EREVs).

### BACKGROUND

Electric vehicles (EVs) generally use charging stations to recharge their batteries. However, not all fast chargers are created equal. Many EV charging stations do not provide the maximum power output that EREVs can accept. Some charging stations may be limited by their power supply, network constraints, or hardware issues. Even when a charging station is rated at a high power (e.g., 150 KW), it may not deliver that speed consistently. This discrepancy leads to longer charging times, which can be inconvenient for drivers.

Furthermore, the availability and quality of charging infrastructure can vary significantly from one location to another. In areas with underdeveloped or unreliable charging networks, drivers may find it challenging to charge their vehicles efficiently. Problems with the charging infrastructure, such as degraded cables, faulty connectors, or software issues, may also lead to reduced charging speeds.

Additionally, prolonged charging periods at charging stations may disrupt travel plans and lead to the inefficient use of time. For drivers who need to quickly recharge their vehicles and get back on the road, long waits can be particularly frustrating and impractical.

As shown in FIG. 1, architecture of a standard extended range electric vehicle (EREV) 100 is provided. The EREV 100 generally comprises a battery 102 configured to power the EREV 100 and an engine 104 (e.g., an internal combustion engine and/or other suitable engine) configured to generate additional power to increase the range of the EREV 100. The EREV 100 generally comprises a front axle 110, a rear axle 112, front wheels 114, rear wheels 116, a front differential 118, and a rear differential 120.

An EREV 100 may comprise a front motor/generator 106 and a rear motor/generator 108. The EREV 100 may have limited all-wheel drive (AWD) availability at a low state of charge (SOC) of the high-voltage battery 102. The front motor/generator 106 is configured to provide two independent functions of (1) charging the high-voltage battery 102 and (2) providing driving torque to a front axle 110, but cannot do both simultaneously. This means that, at a low SOC, the engine 104 must be on and spinning the front motor/generator 106 as a generator to charge the battery 102 and all-wheel drive is unavailable, and the rear motor/generator 108 may be used to apply torque to the rear wheels 116.

### SUMMARY

According to an object of the present disclosure, a method for performing engine-assisted charging for an extended range electric vehicle (EREV) is provided. The method may comprise, using a computing device comprising a processor and a memory, determining whether a maximum output of a charging station, coupled to the EREV, is less than a power receiving capacity of the EREV, and, when the maximum output of a charging station is less than the power receiving capacity of the EREV, enabling engine-assisted charging. Enabling the engine-assisted charging may comprise determining an output needed from a generator of the EREV powered by an engine of the EREV, starting the engine, causing the generator to generate power and causing a battery of the EREV to be charged using the charging station and the generator, and coordinating, using a battery management system, a charging process from both the charging station and the generator.

According to an exemplary embodiment, the method may comprise connecting the charging station to the EREV.

According to an exemplary embodiment, the method may comprise determining the maximum output of the charging station.

According to an exemplary embodiment, the enabling the engine-assisted charging may comprise coordinating a correct voltage and current needed to prevent overcharging of the battery.

According to an exemplary embodiment, the enabling the engine-assisted charging may comprise monitoring an output of the charging station.

According to an exemplary embodiment, the monitoring may be performed continuously during the engine-assisted charging.

According to an exemplary embodiment, the enabling the engine-assisted charging may comprise, as the output of the charging station is being monitored, determining whether the maximum output of the charging station is less than the power receiving capacity of the EREV.

According to an exemplary embodiment, the enabling the engine-assisted charging may comprise, when the maximum output of the charging station is less than the power receiving capacity of the EREV, charging the battery until the battery is full or a state of charge (SOC) of the battery meets a user-defined SOC level.

According to an exemplary embodiment, the method may comprise determining whether engine-assisted charging is enabled.

According to an exemplary embodiment, the method may comprise, when the engine-assisted charging is not enabled, alerting a user and prompting the user to enable the enable the engine-assisted charging.

According to an object of the present disclosure, a system for performing engine-assisted charging for an EREV is provided. The system may comprise an EREV, comprising a battery, an engine, and a computing device comprising a processor and a memory. The memory may be configured to store instructions that, when executed by the processor, are configured to cause the processor to determine whether a maximum output of a charging station, coupled to the EREV, is less than a power receiving capacity of the EREV and, when the maximum output of a charging station is less than the power receiving capacity of the EREV, enable engine-assisted charging. Enabling the engine-assisted charging may comprise determining an output needed from a generator of the EREV powered by an engine of the EREV, starting the engine, causing the generator to generate power and causing a battery of the EREV to be charged using the charging station and the generator, and coordinating, using a battery management system, a charging process from both the charging station and the generator.

According to an exemplary embodiment, the instructions, when executed, may be configured to cause the processor to connect the charging station to the EREV.

According to an exemplary embodiment, the instructions, when executed, may be configured to cause the processor to determine the maximum output of the charging station.

According to an exemplary embodiment, the enabling the engine-assisted charging may comprise coordinating a correct voltage and current needed to prevent overcharging of the battery.

According to an exemplary embodiment, the enabling the engine-assisted charging may comprise monitoring an output of the charging station.

According to an exemplary embodiment, the monitoring may be performed continuously during the engine-assisted charging.

According to an exemplary embodiment, the enabling the engine-assisted charging may comprise, as the output of the charging station is being monitored, determining whether the maximum output of the charging station is less than the power receiving capacity of the EREV.

According to an exemplary embodiment, the enabling the engine-assisted charging may comprise, when the maximum output of the charging station is less than the power receiving capacity of the EREV, charging the battery until the battery is full or an SOC of the battery meets a user-defined SOC level.

According to an exemplary embodiment, the instructions, when executed, may be configured to cause the processor to determine whether engine-assisted charging is enabled.

According to an exemplary embodiment, the instructions, when executed, may be configured to cause the processor to, when the engine-assisted charging is not enabled, alert a user and prompt the user to enable the enable the engine-assisted charging.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates an extended range electric vehicle (EREV).

FIG. 2 illustrates an example EREV utilizing direct current (DC) charging, according to an exemplary embodiment of the present disclosure.

FIG. 3 illustrates an example EREV utilizing alternating current (AC) charging, according to an exemplary embodiment of the present disclosure.

FIG. 4 (includes FIGS. 4A and 4B) illustrates a flowchart of a method for performing engine-assisted charging for an EREV, according to an exemplary embodiment of the present disclosure.

FIG. 5 illustrates an example architecture of a vehicle, according to an exemplary embodiment of the present disclosure,

FIG. 6 illustrates example elements of a computing device, according to an exemplary embodiment of the present disclosure.

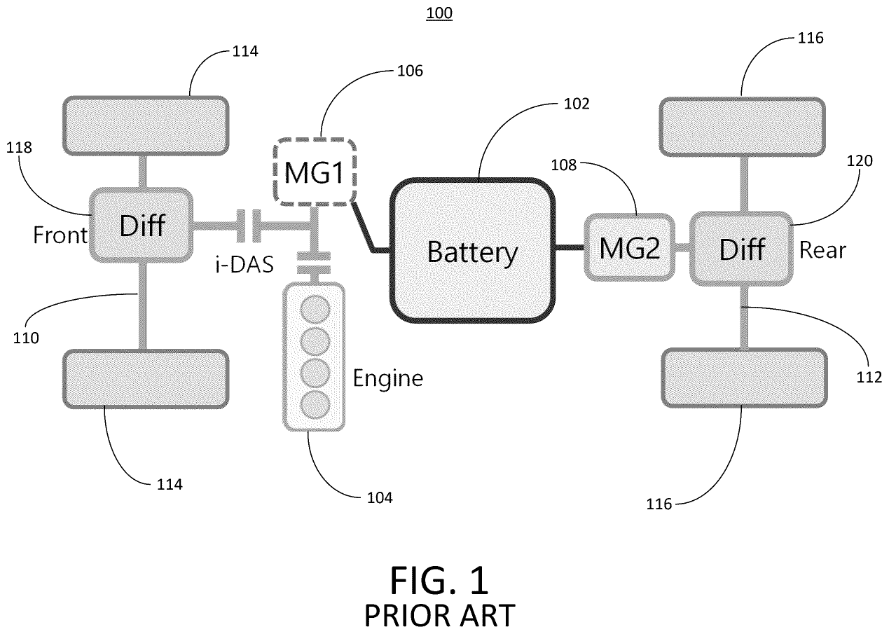

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,”taking,“comparing.” “monitoring,”calibrating.“ ”estimating,“initiating.” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry, The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for performing engine-assisted charging for an extended range electric vehicle (EREV) are provided.

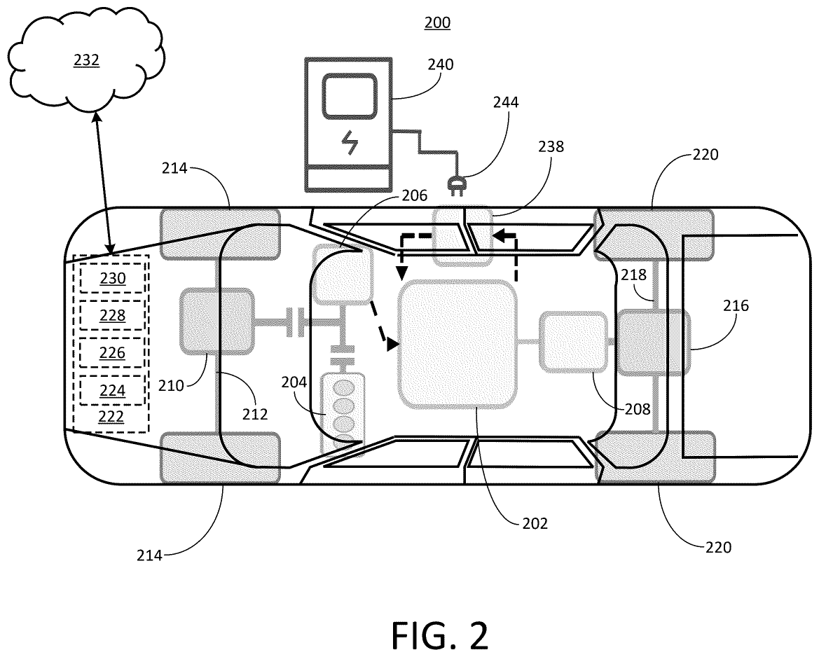

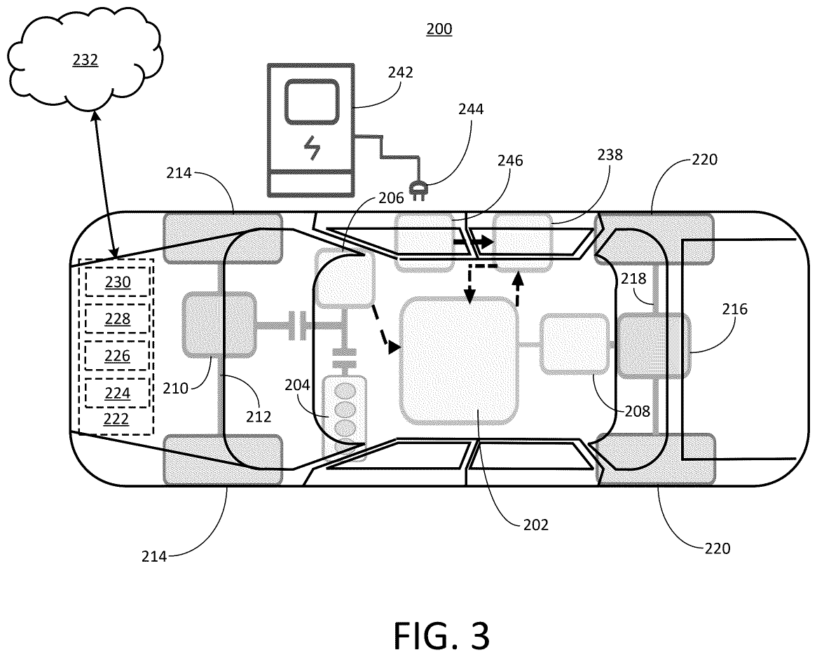

Referring now to FIGS. 2-3, EREVs 200 utilizing direct current (DC) charging (FIG. 2) and alternating current (AC) charging are illustratively depicted, in accordance with exemplary embodiments of the present disclosure.

Standard EREVs follow a standard battery management strategy, which is usually to deplete the high voltage battery first to maximize miles per gallon of gasoline equivalent (MPGe) before using gasoline (which would be used to run the engine and charge the battery). Then, the battery SOC would be low and use the front motor/generator to charge the battery, and the front motor/generator would be unable to be used for driving the front wheels and AWD would be unavailable when required. According to an exemplary embodiment, the EREV 200 solves this problem and provides a solution to the limited AWD availability from existing 2-motor EREV architectures without requiring additional expensive hardware such as, e.g., a third motor (which would be used as a designated generator for charging the battery), According to an exemplary embodiment, a system for performing engine-assisted charging for an EREV 200 may comprise the EREV 200. According to an exemplary embodiment, the EREV 200 may comprise a battery 202, an engine 204, a front motor/generator 206, and a rear motor/generator 208. The EREV 200 may comprise a front differential 210, front axle 212, and front wheels 214, and a rear differential 216, rear axle 218, and rear wheels 220.

According to an exemplary embodiment, the EREV 200 may comprise a battery management system 238. According to an exemplary embodiment, the battery management system 238 may be configured to utilize the engine 204 to run the front motor/generator 206 while connected to a charging station (e.g., DC charging station 240, AC charging station 242, and/or other suitable charging station) via a charging station connector 244.

According to an exemplary embodiment, when the power output of the charging station (e.g., charging station 240, charging station 242, etc.) is lower than a charging capability of the EREV 200, the user may manually activate the engine 204 or the battery management system 238 may be configured to automatically activate the engine 204, providing an alternative charging method.

Upon activation, the engine 204 may be configured to power the front motor/generator 206, supplementing the charging process and decreasing the charging time.

According to an exemplary embodiment, when the charging station is an AC charging station 242, the EREV 200 may comprise an on-board charger (OBC) 246. The OBC 246 may be configured to convert the AC input from the grid into DC power to charge the battery 202.

According to an exemplary embodiment, when the charging station is a DC charging station 240, a DC/DC converter may be configured to manage the DC output from the front motor/generator 206. According to an exemplary embodiment, the DC/DC converter may be a component of the front motor/generator 206 or a separate component. This converter ensures that the DC power from the generator is appropriately conditioned to charge the battery or supply power to the vehicle's systems.

According to an exemplary embodiment, the battery management system 238 may be configured to coordinate the charging process from both power sources (the engine 204 and the charging station). According to an exemplary embodiment, the battery management system 238 may be configured to ensure that the battery 202 receives the correct voltage and current, preventing overcharging and balancing the input from the two sources. With proper coordination, the battery 202 may receive power from both the OBC 246 (AC input) and the DC/DC converter (generator output) simultaneously.

According to an exemplary embodiment, the EREV 200 may comprise a computing device 222. According to an exemplary embodiment, the computing device 222 may be a component of, or coupled to, the battery management system 238. The computing device 222 may comprise a processor 224, a memory 226, a user interface 228 (e.g., a graphical user interface), a transmitter/transceiver 230 in electronic communication with the EREV 200, and/or other suitable components. The computing device 222 may be configured to send and/or receive commands/data/input/etc. via one or more external systems via wired and/or wireless connection (e.g., via the cloud 232).

The memory 226 may be configured to store programming instructions that, when executed by the processor 224, may be configured to cause the processor 224 to perform one or more tasks such as, e.g., determining a maximum output of a charging station, determining if the maximum output less than a maximum output the EREV 200 can receive, when the maximum output of the charging station is less than the maximum power the EREV 200 can receive, determining whether automatic engine assisted charging has been enabled, performing automatic engine assisted charging, determining an output needed from the front motor/generator 206 and coordinate the correct voltage and current needed to prevent overcharging and balancing the input from the two sources, starting the engine 204, enabling the EREV 200 battery 202 to charge simultaneously from both the OBC 246 and the DC/DC converter, coordinating, using the battery management system 238, the charging process from both the charging station and the front motor/generator 206, monitoring the output of the charging station to determine if it remains less than the maximum output, and/or performing one or more other suitable tasks.

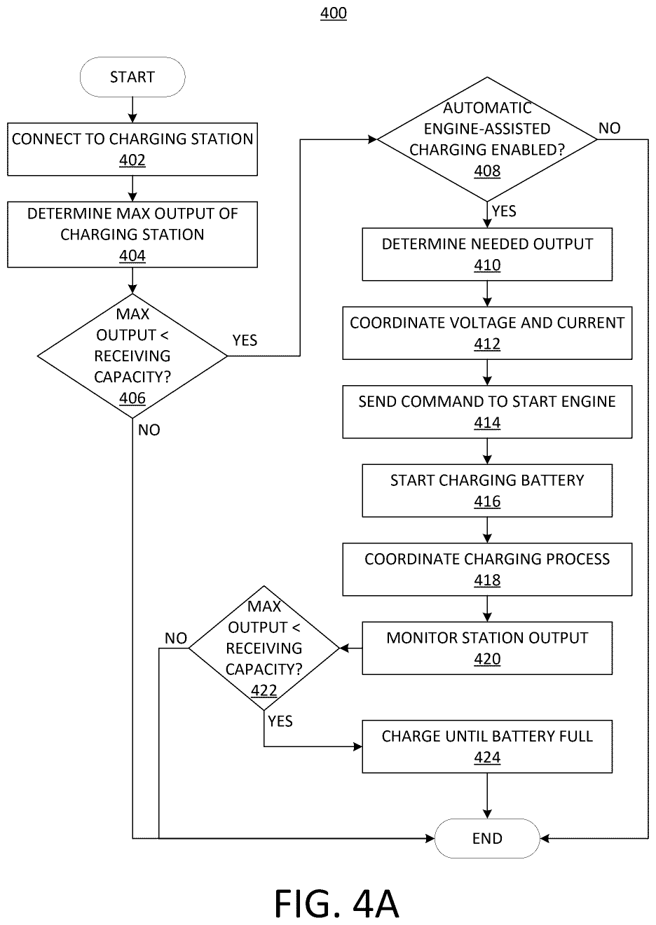

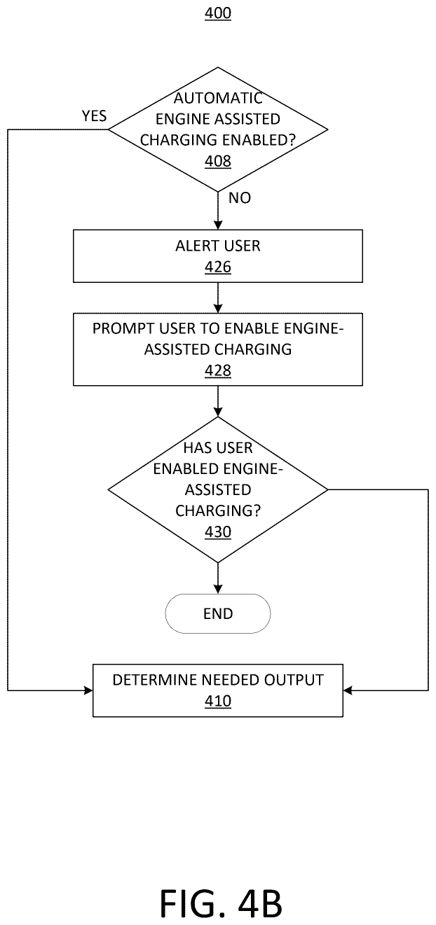

Referring now to FIG. 4, a flowchart of a method 400 for performing engine-assisted charging for an EREV is illustratively depicted, in accordance with an exemplary embodiment of the present disclosure.

At 402, an EREV may be connected to a charging station (e.g., a DC charging station, an AC charging station, and/or other suitable charging station). At 404, the maximum output of the charging station may be determined. According to an exemplary embodiment, the maximum output of the charging station may be performed using the battery management system of the EREV, the computing device of the EREV, and/or via other suitable means.

At 406, it may be determined whether the maximum output of the charging station is less than a maximum power receiving capacity of the EREV. According to an exemplary embodiment, determining whether the maximum output of the charging station is less than the maximum power receiving capacity of the EREV may comprise applying a predetermined threshold for determining whether to initiate engine-assisted charging. For example, the maximum output of the charging station may need to be less than 95% (or other suitable percentage) of the maximum power that the EREV can receive to proceed with engine-assisted charging.

When the max output of the charging station is less than the maximum power that the EREV vehicle can receive, it may be determined, at 408, whether automatic engine-assisted charging has been enabled. According to an exemplary embodiment, automatic engine-assisted charging may be enabled or disabled via an in-vehicle display and/or other suitable means.

According to an exemplary embodiment, when automatic engine-assisted charging is enabled, then, at 410, the output needed from the front motor/generator may be determined and, at 412, the correct voltage and current needed to prevent overcharging may be coordinated, balancing the input from the two sources of power (e.g., the charging station and the front motor/generator). According to an exemplary embodiment, the output needed from the front motor/generator may be calculated according to Equation 1.

(output Needed From Generator)=(maximum power EREV can receive)−(maximum output of the charging station) Equation 1

At 414, a command may be sent to an engine control unit to start the engine. According to an exemplary embodiment, the engine control unit may comprise the computing device of the EREV, the battery management system, and/or other suitable system or device.

At 416, the battery of the EREV begins charging simultaneously from both the OBC and a DC/DC converter and, at 418, the battery management system may coordinate a charging process from both the charging station and the front motor/generator.

During charging, the output of the charging station may be monitored, at 420 to determine if it remains less than the maximum output. According to an exemplary embodiment, the output of the charging station may be monitored continuously during charging At 422, it may be determined whether the maximum output of the charging station exceeds the maximum power that the EREV can receive. When the maximum output of the charging station exceeds the maximum power that the EREV can receive, then the process ends (engine-assisted charging stops). When the maximum output of the charging station does not exceed the maximum power that the EREV can receive, then, at 424, engine-assisted charging continues until the battery is full or the battery state of charge (SOC) meets a user-defined SOC level.

According to an exemplary embodiment, when automatic engine-assisted charging is not enabled, then the process ends. According to an alternative embodiment, as shown, e.g., in FIG. 4B, when automatic engine-assisted charging is not enabled, then, at 426, a user (e.g., the driver) may be alerted that there is the potential to shorten the charging duration of the battery. The user may be alerted via a graphical user interface and/or other suitable means. According to an exemplary embodiment, the user may be prompted, at 428, to enable engine-assisted charging. It may then be determined, at 430, whether the user has enabled the engine-assisted charging.

When the user has enabled engine-assisted charging, then, at 410, the output needed from the front motor/generator may be determined. When the user has not enabled engine-assisted charging, then the process ends (the EREV charges only from the charging station).

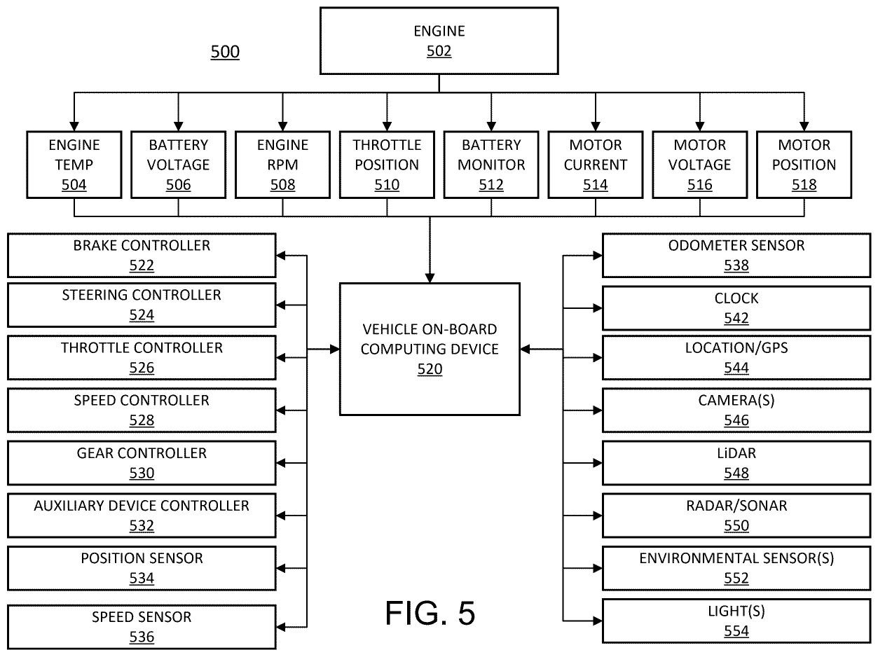

Referring now to FIG. 5, an example vehicle system architecture 500 for a vehicle is provided, in accordance with an exemplary embodiment of the present disclosure. The following discussion of vehicle system architecture 500 is sufficient for understanding one or more components of EREV 200.

As shown in FIG. 5, the vehicle system architecture 500 may comprise an engine, motor or propulsive device 502 and various sensors 504-518 for measuring various parameters of the vehicle system architecture 500, such as, but not limited to, those of the vehicle snapshot described above. In gas-powered or hybrid vehicles having a fuel-powered engine, the sensors 504-518 may comprise, for example, an engine temperature sensor 504, a battery voltage sensor 506, an engine Rotations Per Minute (RPM) sensor 508, and/or a throttle position sensor 510. If the vehicle is an electric or hybrid vehicle, then the vehicle may comprise an electric motor, and accordingly may comprise sensors such as a battery monitoring system 512 (to measure current, voltage and/or temperature of the battery), motor current 514 and voltage 516 sensors, and motor position sensors such as resolvers and encoders 518.

Operational parameter sensors that are common to both types of vehicles may comprise, for example: a position sensor 534 such as an accelerometer, gyroscope and/or inertial measurement unit; a speed sensor 536; and/or an odometer sensor 538. The vehicle system architecture 500 also may comprise a clock 542 that the system uses to determine vehicle time and/or date during operation. The clock 542 may be encoded into the vehicle on-board computing device 520, it may be a separate device, or multiple clocks may be available.

The vehicle system architecture 500 may comprise various sensors that operate to gather information about the environment in which the vehicle is traveling. These sensors may comprise, for example: a location sensor 544 (for example, a Global Positioning System (GPS) device); object detection sensors such as one or more cameras 546; a LIDAR sensor system 548; and/or a radar and/or a sonar system 550. The sensors may comprise environmental sensors 552 such as, e.g., a humidity sensor, a precipitation sensor, a light sensor, and/or ambient temperature sensor. The object detection sensors may be configured to enable the vehicle system architecture 500 to detect objects that are within a given distance range of the vehicle in any direction, while the environmental sensors 552 may be configured to collect data about environmental conditions within the vehicle's area of travel. According to an exemplary embodiment, the vehicle system architecture 500 may comprise one or more lights 554 (e.g., headlights, flood lights, flashlights, etc.).

During operations, information may be communicated from the sensors to an on-board computing device 520 (e.g., computing device 222, processor 224, memory 226, battery management system 238, and computing device 600). The on-board computing device 520 may be configured to analyze the data captured by the sensors and/or data received from data providers and may be configured to optionally control operations of the vehicle system architecture 500 based on results of the analysis. For example, the on-board computing device 520 may be configured to control: braking via a brake controller 522; direction via a steering controller 524; speed and acceleration via a throttle controller 526 (in a gas-powered vehicle) or a motor speed controller 528 (such as a current level controller in an electric vehicle); a differential gear controller 530 (in vehicles with transmissions); and/or other controllers. The brake controller 522 may comprise a pedal effort sensor, pedal effort sensor, and/or simulator temperature sensor, as described herein.

Geographic location information may be communicated from the location sensor 544 to the on-board computing device 520, which may then access a map of the environment that corresponds to the location information to determine known fixed features of the environment such as streets, buildings, stop signs and/or stop/go signals. Captured images from the cameras 546 and/or object detection information captured from sensors such as LiDAR 548 may be communicated from those sensors to the on-board computing device 520. The object detection information and/or captured images may be processed by the on-board computing device 520 to detect objects in proximity to the vehicle. Any known or to be known technique for making an object detection based on sensor data and/or captured images may be used in the embodiments disclosed in this document.

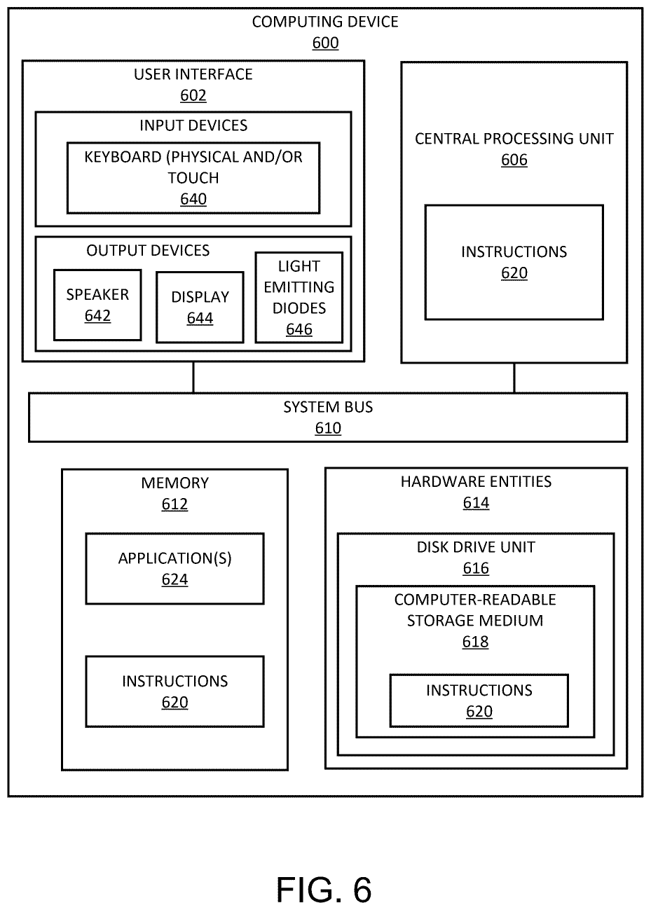

Referring now to FIG. 6, an illustration of an example architecture for a computing device 700 is provided. According to an exemplary embodiment, one or more functions of the present disclosure may be implemented by a computing device such as, e.g., computing device 600 or a computing device similar to computing device 600. Computing device 600 may be a quantum computer, a classical computer, and/or have one or more components configured to perform one or more quantum and/or classical computing functions. Computing device 222, processor 224, memory 226, battery management system 238, and/or computing device 520 may be an example of computing device 600 and/or may comprise one or more components of computing device 600.

The hardware architecture of FIG. 6 represents one example implementation of a representative computing device configured to implement at least a portion of the systems/devices (e.g., EREV 200) and method(s)/control logic(s) (e.g., method 400) described herein.

Some or all components of the computing device 600 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors), The passive and/or active components may be adapted to, arranged to, and/or programmed to perform one or more of the methodologies, procedures, or functions described herein.

As shown in FIG. 6, the computing device 600 may comprise a user interface 602 (e.g., a graphical user interface), a Central Processing Unit (“CPU”) 606, a system bus 610, a memory 612 connected to and accessible by other portions of computing device 600 through system bus 610, and hardware entities 614 connected to system bus 610. The user interface may comprise input devices and output devices, which may be configured to facilitate user-software interactions for controlling operations of the computing device 600. The input devices may comprise, but are not limited to, a physical and/or touch keyboard 640. The input devices may be connected to the computing device 600 via a wired or wireless connection (e.g., a Bluetooth® connection). The output devices may comprise, but are not limited to, a speaker 642, a display 644, and/or light emitting diodes 646, At least some of the hardware entities 614 may be configured to perform actions involving access to and use of memory 612, which may be a Random Access Memory (RAM), a disk driver and/or a Compact Disc Read Only Memory (CD-ROM), among other suitable memory types. Hardware entities 614 may comprise a disk drive unit 616 comprising a computer-readable storage medium 618 on which may be stored one or more sets of instructions 620 (e.g., programming instructions such as, but not limited to, software code) configured to implement one or more of the methodologies, procedures, or functions described herein, The instructions 620 may also reside, completely or at least partially, within the memory 612 and/or within the CPU 606 during execution thereof by the computing device 600, The memory 612 and the CPU 606 may also constitute machine-readable media. The term “machine-readable media”, as used here, refers to a single medium or multiple media (e.g., a centralized or distributed database, and/or associated caches and servers) that store the one or more sets of instructions 620. The term “machine-readable media”, as used here, also refers to any medium that is capable of storing, encoding, or carrying a set of instructions 620 for execution by the computing device 600 and that cause the computing device 600 to perform any one or more of the methodologies of the present disclosure. According to various embodiments, one or more computer applications 624 may be stored on the memory 612.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

1. A method for performing engine-assisted charging for an extended range electric vehicle (EREV), comprising:
using a computing device comprising a processor and a memory:
determining whether a maximum output of a charging station, coupled to the EREV, is less than a power receiving capacity of the EREV by applying a predetermined threshold, the maximum output of the charging station being less than a predetermined percentage of the power receiving capacity of the EREV; and
when the maximum output of a charging station is less than the power receiving capacity of the EREV, enabling engine-assisted charging, comprising:
determining an output needed from a generator of the EREV powered by an engine of the EREV, the output needed from the generator being determined as a difference between the power receiving capacity of the BREV and the maximum output of the charging station;
starting the engine, causing the generator to generate power and causing a battery of the EREV to be charged using the charging station and the generator; and
coordinating, using a battery management system, a charging process from both the charging station and the generator.

2. The method of claim 1, further comprising connecting the charging station to the EREV.

3. The method of claim 1, further comprising determining the maximum output of the charging station.

4. The method of claim 1, wherein the enabling the engine-assisted charging further comprises coordinating a correct voltage and current needed to prevent overcharging of the battery.

5. The method of claim 1, wherein the enabling the engine-assisted charging further comprises monitoring an output of the charging station.

6. The method of claim 5, wherein the monitoring is performed continuously during the engine-assisted charging.

7. The method of claim 5, wherein the enabling the engine-assisted charging further comprises, as the output of the charging station is being monitored, determining whether the maximum output of the charging station is less than the power receiving capacity of the EREV.

8. The method of claim 7, wherein the enabling the engine-assisted charging further comprises, when the maximum output of the charging station is less than the power receiving capacity of the EREV, charging the battery until the battery is full or a state of charge (SOC) of the battery meets a user-defined SOC level.

9. The method of claim 1, further comprising determining whether engine-assisted charging is enabled.

10. The method of claim 9, further comprising, when the engine-assisted charging is not enabled:
alerting a user; and
prompting the user to enable the enable the engine-assisted charging.

11. A system for performing engine-assisted charging for an extended range electric vehicle (EREV), comprising:
an EREV, comprising:
a battery;
an engine; and
a computing device comprising a processor and a memory, wherein the memory is configured to store instructions that, when executed by the processor, are configured to cause the processor to:
determine whether a maximum output of a charging station, coupled to the EREV, is less than a power receiving capacity of the EREV by applying a predetermined threshold, the maximum output of the charging station being less than a predetermined percentage of the power receiving capacity of the BREV; and
when the maximum output of a charging station is less than the power receiving capacity of the EREV, enable engine-assisted charging, comprising:
determining an output needed from a generator of the EREV powered by an engine of the EREV, the output needed from the generator being determined as a difference between the power receiving capacity of the EREV and the maximum output of the charging station;
starting the engine, causing the generator to generate power and causing a battery of the EREV to be charged using the charging station and the generator; and
coordinating, using a battery management system, a charging process from both the charging station and the generator.

12. The system of claim 11, wherein the instructions, when executed, are further configured to cause the processor to connect the charging station to the EREV.

13. The system of claim 11, wherein the instructions, when executed, are further configured to cause the processor to determine the maximum output of the charging station.

14. The system of claim 11, wherein the enabling the engine-assisted charging further comprises coordinating a correct voltage and current needed to prevent overcharging of the battery.

15. The system of claim 11, wherein the enabling the engine-assisted charging further comprises monitoring an output of the charging station.

16. The system of claim 15, wherein the monitoring is performed continuously during the engine-assisted charging.

17. The system of claim 15, wherein the enabling the engine-assisted charging further comprises, as the output of the charging station is being monitored, determining whether the maximum output of the charging station is less than the power receiving capacity of the EREV.

18. The system of claim 17, wherein the enabling the engine-assisted charging further comprises, when the maximum output of the charging station is less than the power receiving capacity of the EREV, charging the battery until the battery is full or a state of charge (SOC) of the battery meets a user-defined SOC level.

19. The system of claim 11, wherein the instructions, when executed, are further configured to cause the processor to determine whether engine-assisted charging is enabled.

20. The system of claim 19, wherein the instructions, when executed, are further configured to cause the processor to, when the engine-assisted charging is not enabled:
alert a user; and
prompt the user to enable the enable the engine-assisted charging.
